(19) United States
(12) Patent Application Publication
(10) Pub. No.: US 2016/0006368 A1
(43) Pub. Date: Jan. 7, 2016

(54) Power Converter

(71) Applicant: HITACHI, LTD., Chiyoda-ku, Tokyo (JP)

(72) Inventors: Nobuhiro KUSUNO, Tokyo (JP); Tomomichi ITO, Tokyo (JP)

(73) Assignee: Hitachi, Ltd., Chiyoda-ku, Tokyo (JP)

(21) Appl. No.: 14/768,999

(22) PCT Filed: Feb. 20, 2013
(86) PCT No.: PCT/JP2013/054072

§ 371 Date: Aug. 19, 2015

(51) Int. Cl. H02M 7/537

(52) U.S. Cl. CPC H02M 7/537

(57) ABSTRACT

A power converter includes semiconductor switching elements conducting when the semiconductor switching elements fail; and open/close units that are disposed between parts having a plurality of different voltage levels and connection portions where the semiconductor switching units, which are to be connected to the parts having the different voltage levels, are connected to each other, and that open or close paths between the parts having the different voltage levels and the connection. When an excess current flows through any one of the open/close units, the one of the open/close unit opens the current path between the part having the corresponding voltage level and the connection portion. Then the power converter does not output the voltage to which the open/close unit is connected, and thereby the number of output voltage levels is reduced.

### TECHNICAL FIELD

The present invention relates to a power converter that includes plural semiconductor switching elements, and outputs plural voltage levels, and further relates to a technology that enables the power converter to continue its power conversion operation even when some of the semiconductor switching elements fail.

### BACKGROUND ART

Power converters such as an inverter and a converter include semiconductor switching elements such as power MOSFETs (metal oxide semiconductor field effect transistors), IGBTs (insulated gate bipolar transistors), GTOs (gate turn off thyristors), and the like. Such power converters can perform various power conversions such as an AC/DC conversion to convert one type of power into other types of power by controlling the on-off operations of those semiconductor switching elements. Therefore, power converters can be used for various applications in which one type of power is converted into other types of power. For example, they are used in, for example, a 50 Hz/60 Hz frequency conversion station of an AC power transmission network in an electric power system, an AC/DC conversion station where an AC power transmission network and a DC power transmission network are connected to each other, a wind power generation system and a solar power generation system whose generated power outputs vary according to natural conditions, and the like.

Since, the failure of a power converter used in an electric power system leads to a blackout, it is required that the power converter should continue its power conversion operation even when some of components included in the power converter fail. In addition, in a wind power generation system or a solar power generation system, since a power generation stoppage owing to the failure of the system influences the profit and loss of the power generation business, it is important to minimize the time period of the power generation stoppage and to improve the capacity utilization ratio of the system. In the case where the installation location of a power generation system cannot be easily accessed, for example, in the case of on the ocean or in a mountainous area, it is especially important that the power generation system can continue its operation even if some power converters fail.

A technology that enables a power converter to continue its operation even in the case of such a failure is disclosed, for example, in Patent Literature 1. The Patent Literature discloses a technology in which a power converter is configured in such a way that the power converter includes at least two phase modules, each of which includes single-phase power conversion modules connected serially in large numbers, and if a single-phase power conversion module included in one phase module fails, the output voltage of a single-phase power conversion module that is included in the other normal phase module of the at least two phase modules and that corresponds to the failed single-phase power conversion module is controlled to be set zero so that the power conversion is continued.

### CITATION LIST

### Patent Literature

Patent Literature 1: Japanese Unexamined Patent Application Publication (Translation of PCT Application) No. 2009-509483

### SUMMARY OF INVENTION

### Technical Problem

However, according to the technology disclosed in Patent Literature 1, in the power converter including the phase modules having single-phase power conversion modules connected in multiple series, it is required that the output voltages of single-phase power conversion modules that are included in the normal phase modules and that correspond to the failed power conversion module should be controlled to be set zero, therefore the maximum value of the available output voltage is reduced. If the power converter has a comparably high output voltage, the number of single-phase power conversion modules connected in multiple series is large, therefore when a few single-phase power modules included in one phase module fail, even if the output voltages of other normal corresponding phase modules are controlled to be set zero, the maximum value of the available output voltage is not reduced very much. Meanwhile, in the case where a system having a comparatively small output voltage such as a wind power generation system or a solar power generation system includes single-phase power conversion modules connected in multiple series, because the required number of single-phase power conversion modules is small, the maximum value of the available output voltage at the time of failure is largely reduced, so that it becomes necessary for the power converter to be operated in a reduced conversion power mode.

On the other hand, in the case where the number of single-phase power conversion modules, which have low output voltages and are connected in multiple series, is increased in order to decrease the reduction of the maximum value of the available output voltage at the time of failure small, the required number of semiconductor switching elements becomes, which causes the number of total parts to increase greatly.

Further, in the case of a power converter that includes phase modules having semiconductor switching elements connected in multiple parallel, in order not to disturb the switching operations of normal semiconductor switching elements connected in parallel to a failed semiconductor switching element, it is necessary to electrically disconnect the failed semiconductor switching element from the relevant multiple parallel circuit. This causes the maximum value of the conductible current to be reduced, so that it becomes necessary for the power converter to be operated in a reduced conversion power mode.

As described above, in the case where the power converter is configured with single-phase power conversion modules connected in multiple series and semiconductor switching elements connected in multiple parallel in order for the power converter to continue its power conversion operation at the time when a semiconductor switching element fails, the redundancy of the number of parts and the operation of the power converter in a reduced output power mode at the time of failure are unavoidable. A power converter with a comparably low output voltage is greatly influenced and the reduction of its output power becomes obvious.

The present invention is achieved with the abovementioned problems in mind, and one of the objects of the present invention is to provide a power converter that outputs plural voltage levels and is capable of continuing a power conversion operation without reducing its output power even when some of semiconductor switching elements fail.

### Solution to Problem

In order to solve the abovementioned problem, in a power converter according to the present invention, plural semiconductor switching units, each including an on-off switchable semiconductor switching element and a rectifying element connected to the semiconductor switching element in antiparallel, are connected, when a DC voltage is applied to the power converter, the DC voltage is divided into plural different voltage levels, parts having the plural different voltage levels and connection portions where the semiconductor switching units are connected to each other are electrically connected to each other, and the plural different voltage levels are output using the DC voltage by switching the semiconductor switching elements on and off. Any one of the semiconductor switching elements becomes conductive when it fails. The power converter further includes open/close units disposed between the parts having the plural different voltage levels and the connection portions where the semiconductor switching units, which are to be connected to the parts having the different voltage levels, are connected to each other, when an excess current flows through any one of open/close units, the open/close unit opens a current path between the part having the corresponding voltage level and the connection portion where the corresponding semiconductor switching units are connected to each other, the open/close states of the open/close units are detected, and when any one of the open/close units is in an open state, the voltage to which the open/close unit is connected is not output, thereby the number of output voltage levels is reduced.

According to the present invention, a power converter outputting plural voltage levels and capable of continuing its power conversion operation without reducing its output power even when some of semiconductor switching circuits fail can be provided.

### BRIEF DESCRIPTION OF DRAWINGS

FIG. 1(A) is a diagram showing the main circuit configuration of one phase unit of a diode clamp type five-level converter according to a first embodiment of the present invention.

FIG. 1(B) is a diagram showing a control unit of one phase unit of the diode clamp type five-level converter shown in FIG. 1(A).

FIG. 2 is a schematic diagram for explaining an on-off control method for semiconductor switching elements of the five-level converter.

FIG. 3 is a diagram showing a short-circuit current route in the case where a semiconductor switching element S₁ fails.

FIG. 4 is a diagram showing a short-circuit current route in the case where a semiconductor switching element S₂ fails.

FIG. 5 is a diagram showing a short-circuit current route in the case where a semiconductor switching element S₃ fails.

FIG. 6 is a diagram showing a short-circuit current route in the case where a semiconductor switching element S₄ fails.

FIG. 7 is a diagram showing a short-circuit current route in the case where a semiconductor switching element S′₁ fails.

FIG. 8 is a diagram showing a short-circuit current route in the case where a semiconductor switching element S′₂ fails.

FIG. 9 is a diagram showing a short-circuit current route in the case where a semiconductor switching element S′₃ fails.

FIG. 10 is a diagram showing a short-circuit current route in the case where a semiconductor switching element S′₄ fails.

FIG. 11(A) is a diagram showing the main circuit configuration of one phase unit of the diode clamp type five-level converter in the case where a breaking circuit unit B₁ is activated.

FIG. 11(B) is a diagram showing the control unit in the case of FIG. 11(A).

FIG. 12 is a schematic diagram for explaining an on-off control method for semiconductor switching elements of the diode clamp type five-level converter in the case where the breaking circuit unit B₁ is activated.

FIG. 13(A) is a diagram showing the main circuit configuration of one phase unit of the diode clamp type five-level converter in the case where a breaking circuit unit B₀ is activated.

FIG. 13(B) is a diagram showing the control unit in the case of FIG. 13(A).

FIG. 14 is a schematic diagram for explaining an on-off control method for semiconductor switching elements of the diode clamp type five-level converter in the case where the breaking circuit unit B₀ is activated.

FIG. 15(A) is a diagram showing the main circuit configuration of one phase unit of a diode clamp type five-level converter according to a second embodiment of the present invention.

FIG. 15(B) is a diagram showing a control unit of one phase unit of the diode clamp type five-level converter shown in FIG. 15(A).

FIG. 16 is a diagram showing the main circuit configuration of one phase unit of an active clamp type three-level converter.

FIG. 17 is a diagram showing the main circuit configuration of one phase unit of a flying capacitor type three-level converter.

### DESCRIPTION OF EMBODIMENTS

Hereinafter, embodiments preferable for a power converter according to the present invention to be materialized will be described in detail with reference to the accompanying drawings. In addition, the same reference signs will be assigned to components common throughout the respective drawings, and duplicate explanations will be omitted. The followings are only explanatory embodiments, and the embodiments of the present invention are not limited to the following concrete embodiments.

### First Embodiment

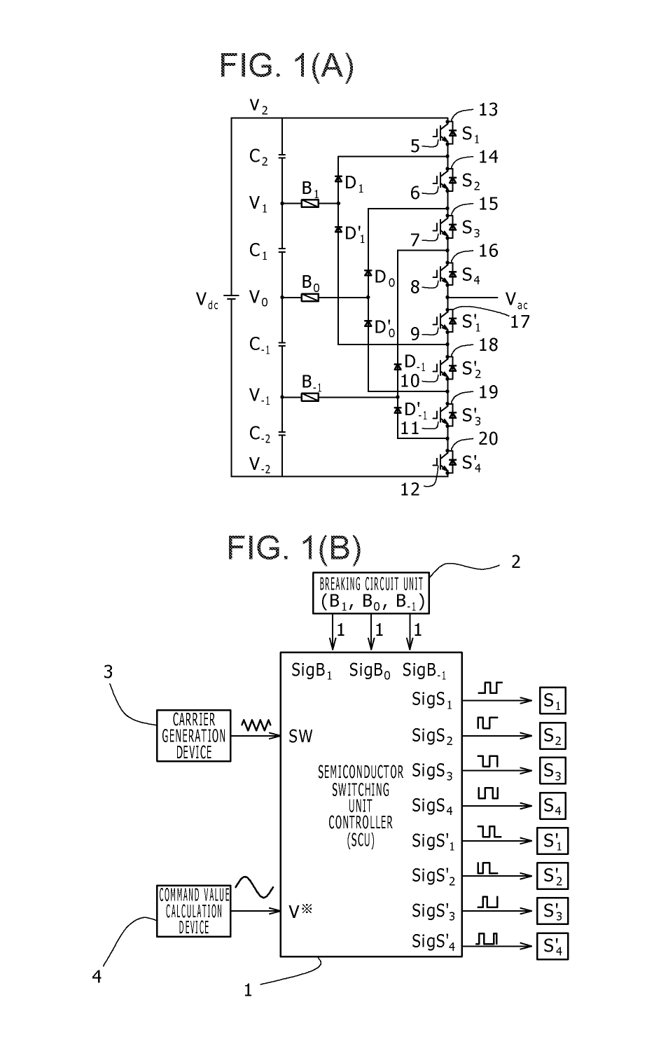

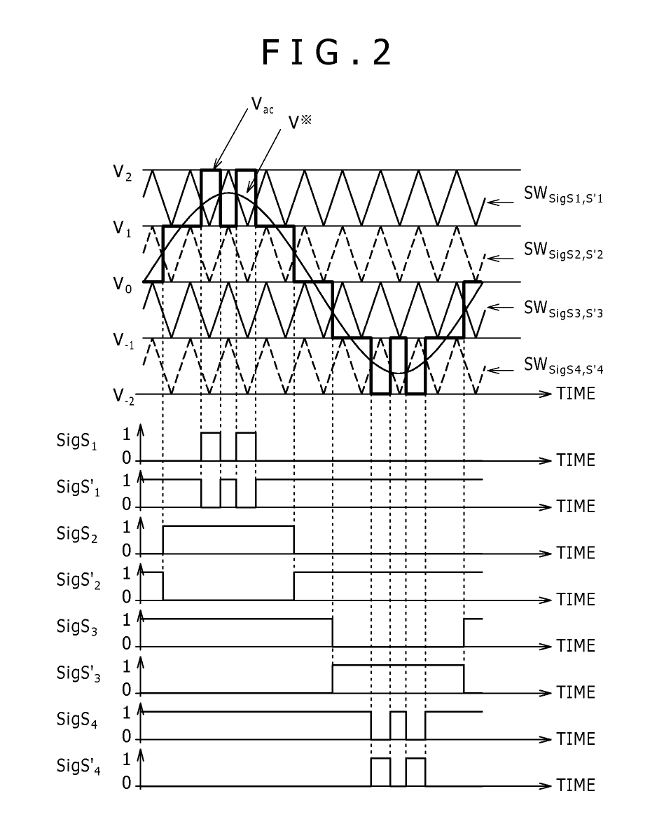

FIG. 1(a) is a diagram showing the main circuit configuration and control device for one phase unit according to a first embodiment in a diode clamp type power converter, which outputs five different voltage levels, according to a first embodiment. Hereinafter, this type of converter will be abbreviated to a five-level converter, and the same type of converter that outputs X voltage levels will be abbreviated to an X-level converter.

As shown in FIG. 1(a), one phase unit of the 5-level converter is configured in the following way. Semiconductor switching units S (S₁, S₂, S₃, S₄, S′₁, S′₂, S′₃, S′₄) respectively include semiconductor switching elements 5 to 12, to which diodes 13 to 20 which are free wheeling rectifying elements are respectively connected in antiparallel, and the semiconductor switching units S (S₁, S₂, S₃, S₄, S′₁, S′₂, S′₃, S′₄) are connected in series in this order. One end of a combination of the semiconductor switching units S connected in the above manner is connected to the maximum voltage level point V₂, and the other end is connected to the minimum voltage level point V₋₂. In addition, the connection points of neighboring semiconductor switching units S are respectively connected to different voltage level points V₁, V₀, and V₋₁ that are obtained through voltage division performed by capacitors C₂, C₁, C₋₁, C₋₂ via diode elements D (D₁, D′₁, D₀, D′₀, D₋₁, D′₋₁) and breaking circuit units B (B₁, B₀, B₋₁) . The higher voltage level side of the capacitor C₂ is connected to the maximum voltage level point V₂, and the voltage level of the lower voltage level side becomes V₁ as a result of the voltage division. The higher voltage level side of the capacitor C₁ is connected to V₁, and the voltage level of the lower voltage level side becomes V₀ as a result of the voltage division.

Vo is the central voltage level in this five-level converter. The higher voltage level side of the capacitor C₋₁ is connected to V₀, and the voltage level of the lower voltage level side becomes V₋₁ as a result of the voltage division. The higher voltage level side of the capacitor C₋₂ is connected to V₋₁, and the lower voltage level side is connected to the minimum voltage level point V₋₂ . The diode elements D₁ and D′₁ are disposed in such a way that the rectification directions of both diode elements D₁ and D′₁ coincide with each other in a parallel circuit connected between the connection point of S₁ and S₂ and the connection point of S′₁ and S′₂, and the connection point between the diode elements D₁ and D′₁, the voltage level point V₁ obtained by the voltage division is connected and the breaking circuit unit B₁ is disposed on the connection route. Furthermore, the diode elements D₀ and D′₀ are disposed in such a way that the rectification directions of both diode elements D₀ and D′₀ coincide with each other in a parallel circuit connected between the connection point of S₂ and S₃ and the connection point of S′₂ and S′₃, the connection point between the diode elements D₀and D′₀ and the voltage level point V₀ obtained by the voltage division is connected, and the breaking circuit unit B₀ is disposed on the connection route. In addition, the diode elements D₋₁ and D′₋₁ are disposed in such a way that the rectification directions of both diode elements D₋₁ and D′₋₁ coincide with each other in a parallel circuit connected between the connection portion of S₃ and S₄ and the connection portion of S′₃ and S′₄, the connection point between the diode elements D₋₁ and D′₋₁ and the voltage level point V₋₁ obtained by the voltage division is connected, and the breaking circuit unit B₋₁ is disposed on the connection route. The five-level converter includes plural phase units that are configured in the above way and disposed in parallel with a DC section. Furthermore, although semiconductor switching elements are depicted by IGBT element symbols in FIG. 4, the semiconductor switching elements are not limited to IGBTs, and may be any semiconductor switching element such as MOSFETs, and thyristors. Here, each of the breaking circuit units B includes a mechanism that cuts off its electric connectivity when an excess current flows through itself.

In addition, each of the semiconductor switching units S includes a mechanism that brings a semiconductor switching element into a conductive state when the semiconductor switching element fails. This mechanism may be, for example, a pressure contact type semiconductor switching element that goes into a short-conductive state when it fails, a semiconductor switching element having a normally-on characteristic that makes itself in a conductive state with no external control signal applied thereto, any semiconductor switching element having a short circuit such as an electromagnetic contact device connected in parallel, or the like. Any semiconductor switching unit may be used as one of the semiconductor switching units as long as it has a mechanism that goes into a short-circuited state when it fails.

Furthermore, each of the breaking circuit units B that cuts off its electric connectivity when an excess current flows through itself may be, for example, a fuse whose conductive route melts down owing to heat energy generated by an excess current; a current breaking device that cuts off its conductive route after detecting an excess current by a current sensor or the like; a mechanism that realizes an excess current breaking function using a combination of a semiconductor switching element and a current sensor for detecting an excess current; a route breaking device that can be operated by an external command signal, or the like. Needless to say, a mechanism other than the above-described devices can be used as long as it is a mechanism having a function of breaking its conductive route (without receiving an external command).

Furthermore, as for the disposal positions of the breaking circuit units B, the breaking circuit units B can be disposed at any positions of the routes on electric circuits in such a way that the breaking circuit units B can electrically break the conductive routes that electrically connect the different voltage level points V₁, V₀, V₋₁ divided by the capacitors and the respective connection points of semiconductor switching units S₁ to S′₄. For example, it is all right that the breaking circuit unit B₁ exerts a function to simultaneously break the conductive route between the connection point of the semiconductor switching units S₁ and S₂ and the voltage level V₁ and the conductive route between the connection point of the semiconductor switching units S′₁ and S′₂ and the voltage level V₁, therefore it is conceivable that a combination of mechanisms disposed on plural positions of the circuit is assigned to the breaking circuit unit B₁.

A voltage command V* output from a command value calculation device 4, a carrier wave signal SW output from a carrier generation device 3, and binary signals SigB₁, SigB₀, SigB₋₁ showing the open/close states of the breaking circuit units 2 (B) are input into a semiconductor switching unit controller 1 (SCU). Although it is assumed that an open state and a close state will be respectively depicted by 0 and 1 in the embodiments in this specification, it goes without saying that the way to express an open state and a close state is not limited to this notation. The semiconductor switching unit controller 1 outputs rectangular wave type control signals SigS₁ to SigS′₄ for respectively controlling the on-off operations of the semiconductor switching units S₁ to S′₄. The rectangular wave type control signals output from the semiconductor switching units S are respectively activated as four pairs of (SigS₁, SigS′₁), (SigS₂, SigS′₂), (SigS₃, SigS′₃), and (SigS₄, SigS′₄), so that two semiconductor switching units included in each of four pairs of the semiconductor switching units (S₁, S′₁), (S₂, S′₂), (S₃, S′₃), and (S₄, S′₄) are controlled not to go into a conductive state simultaneously. The above mechanism for preventing the simultaneous conductive state from occurring is generally referred to as dead-time control, and the compensation of output voltages performed by the introduction of the dead-time is referred to as dead-time compensation. Since the dead-time processing does not contribute to the development of the advantageous effects of the present invention, the explanation about this processing will be omitted.

FIG. 2 shows the outline of signal calculation performed by the internal processing of the semiconductor switching unit controller. The input carrier wave signal SW is expanded, shrunk, or shifted according to the signals SigB₁, SigB₀, and SigB₋₁showing the open/close states of the breaking circuit units. FIG. 2 diagrammatically shows the case where all the SigB₁, SigB₀, and SigB₋₁ show the close states 1. The respective breaking circuit units B₁, B₀, and B₋₁ can output the corresponding voltage levels V₁, V₀, and V₋₁, and four carrier wave signals SW_{SigS1,S′1}, SW_{SigS2,S′2}, SW_{SigS3,S′3}, and SW_{SigS4, S′4}, which respectively have their own amplitudes defined by available output voltage levels V₂, V₁, V₀, V₋₁, and V₋₂, are calculated from the carrier wave signal SW. The rectangular wave type control signals SigS₁ to SigS′₄, which respectively control the on-off operations of the semiconductor switching units S₁ to S′₄, are calculated by comparing the calculated four carrier wave signals SW_{SigS1,S′1}, SW_{SigS2,S′2}, SW_{SigS3,S′3}, and SW_{SigS4, S′4}, with the input voltage command V* respectively. For example, the rectangular wave type control signals SigS₁ and SigS′₁ for the semiconductor switching units S₁ and S′₁ are given in such a way that, if comparison calculation V*≧SW_{SigS1,S′1} is satisfied, (SigS₁, SigS′₁)=(1,0), and otherwise, (SigS₁, SigS′₁)=(0,1), where the conductive state command and the nonconductive state command to the semiconductor switching units S are respectively represented as 1 and 0. By performing the above comparison processing to a pair of the semiconductor switching units S₁ and S′₁and a pair of the semiconductor switching units S₂ and S′₂, the rectangular wave type control signals SigS₁ to SigS′₄ that control the on-off operations of the semiconductor switching units S are calculated, and the semiconductor switching units S₁ to S′₄ are turned on and off according to these control signals, which enables the five-level converter to output a stepped AC voltage V_{ac} including five different voltage levels V₂, V₁, V₀, V₋₁, and V₋₂. In addition, although the carrier wave signals SW_{SigS1,S′1}, to SW_{SigS4,S′4} shown in FIG. 2 are in the same phases, the phases of carrier wave signals adjacent to each other in the vertical direction, that is, the phases of SW_{SigS1,S′1} and SW_{SigS2,S′2}, or the phases of SW_{SigS2,S′2} and SW_{SigS3,S′3}, or the phases of SW_{SigS3,S′3} and SW_{SigS4,S′4} can be opposite to each other, or further the phases of carrier wave signals can be opposite to each other with a specified voltage level as a boundary.

Hereinafter, the case where the respective semiconductor switching units S₁ to S′₄ are short-circuitedly failed will be explained. As described above, each of the semiconductor switching units S has a function to go into a conductive state when it fails, and becomes always on when it is short-circuitedly failed.

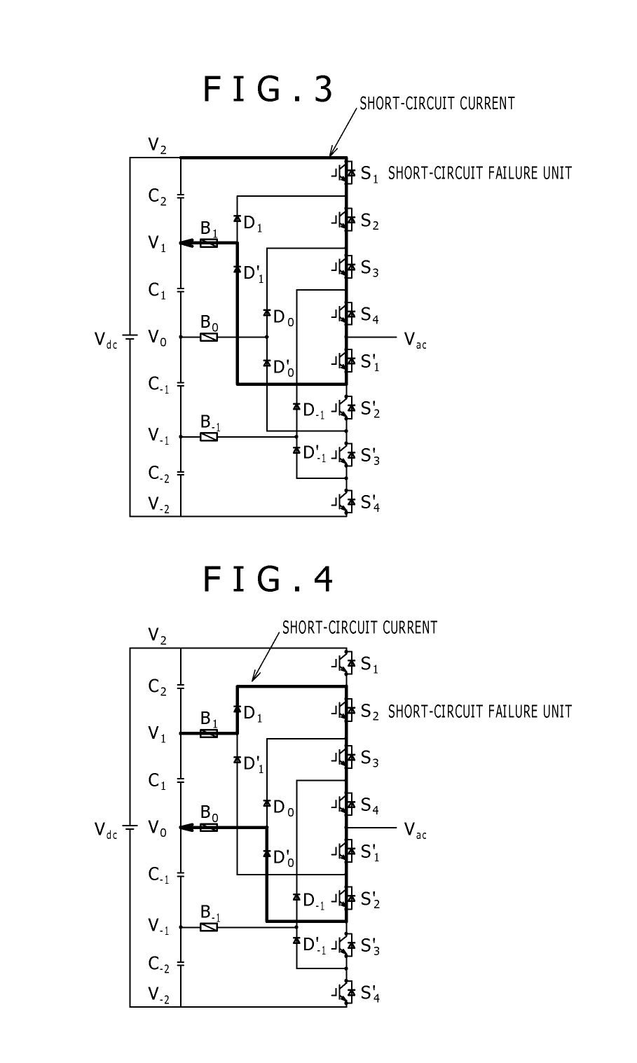

In the case where the semiconductor switching unit S₁ fails short-circuitedly, if the rectangular wave type control signals SigS₁ to SigS′₄ for outputting the voltage V₁ are provided, these rectangular wave type control signals (SigS₁, SigS₂, SigS₃, SigS₄, SigS′f₁ SigS′₂, SigS′₃, SigS′₄) become (0, 1, 1, 1, 1, 0, 0, 0). However, since the semiconductor switching unit S₁ is always on, the semiconductor switching units S₁ to S₄, and S′₁ are conductive. Therefore, electric energy stored in the capacitor C₂ is discharged as a short-circuit current through a route shown in FIG. 3. This causes an excess current to flow through the breaking circuit unit B₁, so that the breaking circuit unit B₁, which breaks its electric connection by an excess current, breaks its current route.

In the case where the semiconductor switching unit S₂ fails short-circuitedly, if the rectangular wave type control signals SigS₁ to SigS′₄ for outputting the voltage V₀ are provided, these rectangular wave type control signals (SigS₁, SigS₂, SigS₃, SigS₄, SigS′₁, SigS′₂, SigS′₃, SigS′₄) become (0, 0, 1, 1, 1, 1, 0, 0). However, since the semiconductor switching unit S₂ is always on, the semiconductor switching units S₂ to S₄, and S′₁ and S′₂ are conductive. Therefore, electric energy stored in the capacitor C₁ is discharged as a short-circuit current through a route shown in FIG. 4. This causes an excess current to flow through the breaking circuit units B₁ and B₀. However, if both breaking circuit units B₁ and B₀ simultaneously exert their current breaking functions, neither voltage levels of the voltages V₁ and V₂ can be output, therefore the breaking circuit units B are respectively given different times for their current breaking functions to be exerted. As a result, only one of breaking circuit units B₁ and B₀ exerts its current breaking function and breaks its current route.

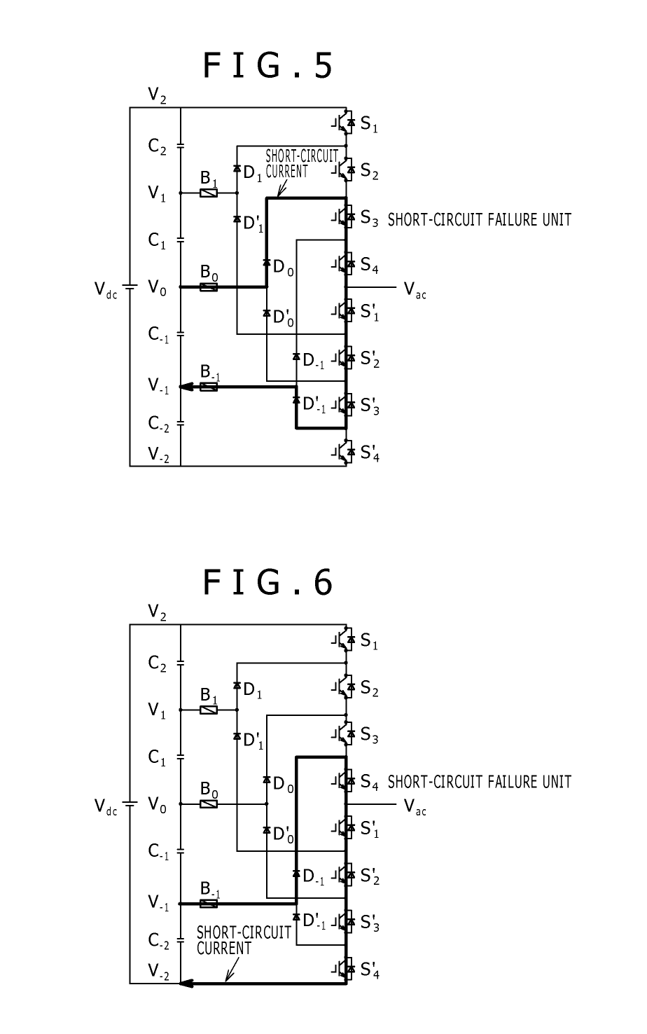

In the case where the semiconductor switching unit S₃ fails short-circuitedly, if the rectangular wave type control signals SigS₁ to SigS′₄ for outputting the voltage V₋₁ are provided, these rectangular wave type control signals (SigS₁, SigS₂, SigS₃, SigS₄, SigS′₁, SigS′₂, SigS′₃, SigS′₄) become (0, 0, 0, 1, 1, 1, 1, 0). However, since the semiconductor switching unit S₃ is always on, the semiconductor switching units S₃ and S₄, and S′₁ to S′₃ are conductive. Therefore, electric energy stored in the capacitor C₋₁ is discharged as a short-circuit current through a route shown in FIG. 5. This causes an excess current to flow through the breaking circuit units B₀ and B₋₁. However, if both breaking circuit units B₀ and B₋₁ simultaneously exert their current breaking functions, neither voltage levels of the voltages V₀ and V₋₁ can be output, therefore the breaking circuit units B are respectively given different times for their current breaking functions to be exerted. As a result, only one of breaking circuit units B₀ and B₋₁ exerts its current breaking function and breaks its current route.

In the case where the semiconductor switching unit S₄ fails short-circuitedly, if the rectangular wave type control signals SigS₁ to SigS′₄ for outputting the Voltage₋₂ are provided, these rectangular wave type control signals (SigS₁, SigS₂, SigS₃, SigS₄, SigS′₁, SigS′₂, SigS′₃, SigS′₄) become (0, 0, 0, 0, 1, 1, 1, 1). However, since the semiconductor switching unit S₄ is always on, the semiconductor switching units S₄ and S′₁ to S′₄ are conductive. Therefore, electric energy stored in the capacitor C₋₂ is discharged as a short-circuit current through a route shown in FIG. 6. This causes an excess current to flow through the breaking circuit unit B₋₁, so that the breaking circuit unit B₋₁, which breaks its electric connection by an excess current, breaks its current route.

In the case where the semiconductor switching unit S′₁ fails short-circuitedly, if the rectangular wave type control signals SigS₁ to SigS′₄ for outputting the voltage V₂ are provided, these rectangular wave type control signals (SigS₁, SigS₂, SigS₃, SigS₄, SigS′₁, SigS′₂, SigS′₃, SigS′₄) become (1, 1, 1, 1, 0, 0, 0, 0). However, since the semiconductor switching unit S′₄ is always on, the semiconductor switching units S₁ to S₄ and S′₁ are conductive. Therefore, electric energy stored in the capacitor C₂ is discharged as a short-circuit current through a route shown in FIG. 7. This causes an excess current to flow through the breaking circuit unit B₁, so that the breaking circuit unit B₁, which breaks its electric connection by an excess current, breaks its current route.

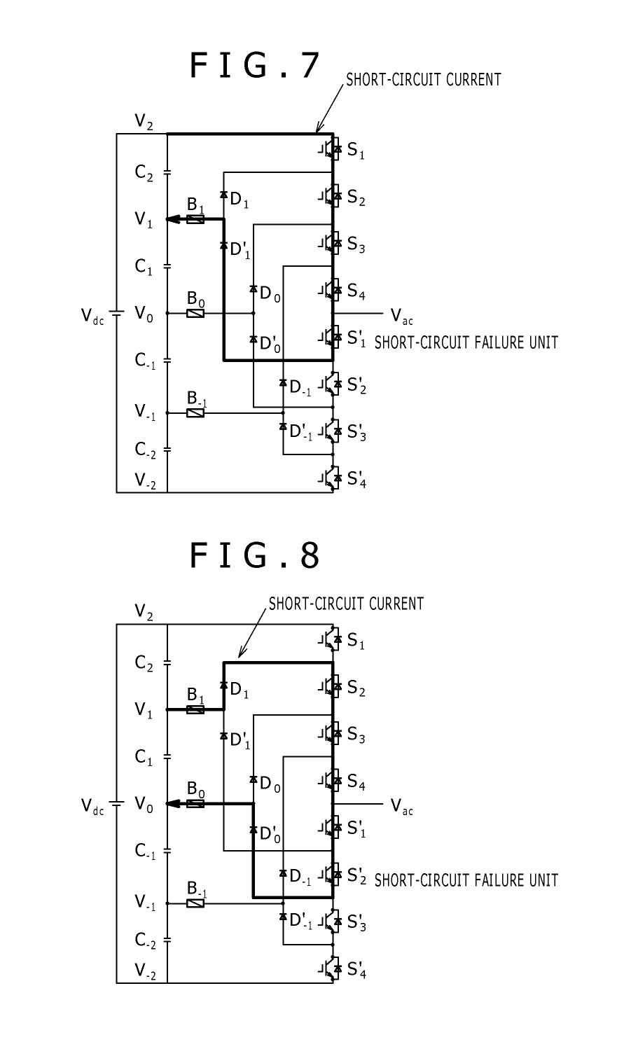

In the case where the semiconductor switching unit S′₂ fails short-circuitedly, if the rectangular wave type control signals SigS₁ to SigS′₄ for outputting the voltage V₁ are provided, these rectangular wave type control signals (SigS₁, SigS₂, SigS₃, SigS₄, SigS′₁, SigS′₂, SigS′₃, SigS′₄) become (0, 1, 1, 1, 1, 0, 0, 0). However, since the semiconductor switching unit S′₂ is always on, the semiconductor switching units S₂ to S₄, and S′₁ and S′₂ are conductive. Therefore, electric energy stored in the capacitor C₁ is discharged as a short-circuit current through a route shown in FIG. 8. This causes an excess current to flow through the breaking circuit units B₁ and B₀. However, if both breaking circuit units B₁ and B₀ simultaneously exert their current breaking functions, neither voltage levels of the voltages V₁ and V₀ can be output, therefore the breaking circuit units B are respectively given different times for their current breaking functions to be exerted. As a result, only one of breaking circuit units B₁ and B₀ exerts its current breaking function and breaks its current route.

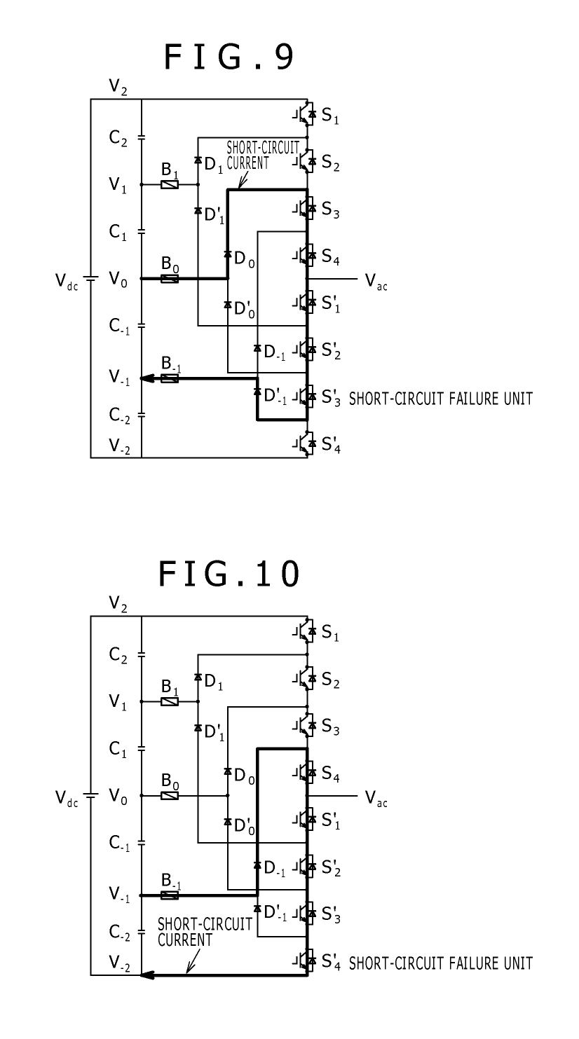

In the case where the semiconductor switching unit S′₃ fails short-circuitedly, if the rectangular wave type control signals SigS₁ to SigS′₄ for outputting the voltage V₀ are provided, these rectangular wave type control signals (SigS₁, SigS₂, SigS₃, SigS₄, SigS′₁, SigS′₂, SigS′₀, SigS′₄) become (0, 0, 1, 1, 1, 1, 0, 0). However, since the semiconductor switching unit S′₃ is always on, the semiconductor switching units S₃ and S₄, and S′₁ to S′₃ are conductive. Therefore, electric energy stored in the capacitor C₋₁ is discharged as a short-circuit current through a route shown in FIG. 9. This causes an excess current to flow through the breaking circuit units B₀ and B₋₁. However, if both breaking circuit units B₀ and B₋₁ simultaneously exert their current breaking functions, neither voltage levels of the voltages V₀ and V₋₁ can be output, therefore the breaking circuit units B are respectively given different times for their current breaking functions to be exerted so that only one of the breaking circuit units B₀ and B₋₁ functions. In other words, the breaking circuit units B are designed so that they are respectively given different times for their current breaking functions to be exerted. As a result, only one of breaking circuit units B₀ and B₋₁ exerts its current breaking function and breaks its current route.

In the case where the semiconductor switching unit S′₄ fails short-circuitedly, if the rectangular wave type control signals SigS₁ to SigS′₄ for outputting the voltage₋₁ are provided, these rectangular wave type control signals (SigS₁, SigS₂, SigS₃, SigS₄, SigS′₁, SigS′₂, SigS′₃, SigS′₄) become (0, 0, 0, 1, 1, 1, 1, 0). However, since the semiconductor switching unit S′₄ is always on, the semiconductor switching units S₄ and S′₁ to S′₄ are conductive. Therefore, electric energy stored in the capacitor C₋₂ is discharged as a short-circuit current through a route shown in FIG. 10. This causes an excess current to flow through the breaking circuit unit B₋₁, so that the breaking circuit unit B₋₁, which breaks its electric connection by an excess current, breaks its current route.

As described above, if any one of the semiconductor switching units S₁ to S′₄ is short-circuitedly failed, a short-circuit current is cut off by any one of the breaking circuit units B₁, B₀, and B₋₁. Furthermore, in order to surely cut off the short-circuit current, the power conversion operation can be stopped for a short time as needed. It becomes possible to use a disconnecting unit, which does not have a current breaking function but has a disconnecting function, instead of a breaking circuit unit, by allowing the power conversion operation to be stopped for a short time.

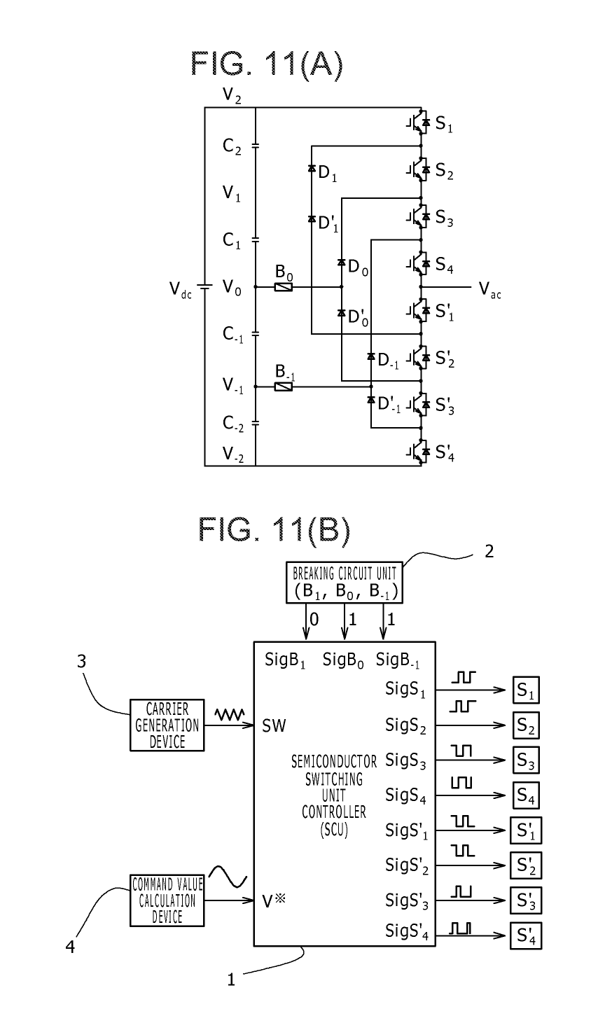

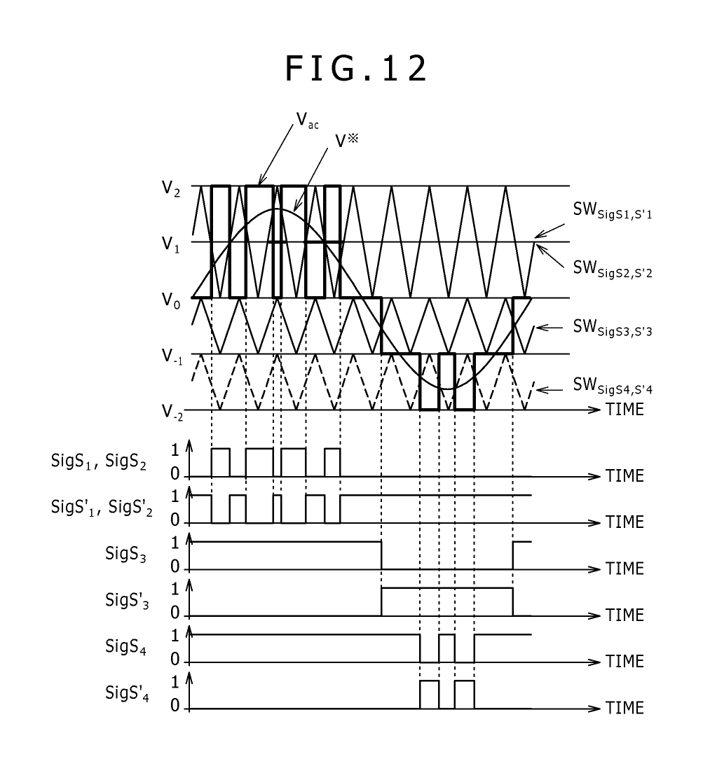

The semiconductor switching unit controller 1 for the five-level converter will be explained in the case where the breaking circuit unit B₁ is activated as shown in FIG. 11(b). As shown in FIG. 11(a), since the breaking circuit unit B₁ is activated, the open/close state signals (SigB₁, Sigb₀, and SigB₋₁) output from the breaking circuit units, which are equal to (0, 1, 1), are input into the semiconductor switching unit controller. The semiconductor switching unit controller detects that the voltage level V₁ cannot be output judging from these signals, and expands, shrinks, and shifts the input carrier wave signal SW as shown in FIG. 12. In other words, the carrier wave signal SW_{SigS1,S′1}, which has been expanded, shrunk, and shifted in the voltage level interval V₂-V₁ in the normal state, is expanded, shrunk, and shifted in the voltage level interval V₂-V₀, and in a similar way, the carrier wave signal SW_{SigS2,S′2}, which has been expanded, shrunk, and shifted in the voltage level interval V₁-V₀ in the normal state, is expanded, shrunk, and shifted in the voltage level interval V₂-V₀. This calculation makes the carrier wave signals SW_{SigS1,S′1}, and SW_{SigS2,S′2} have the same values.

Subsequently, in a similar way to the normal state, the rectangular wave type control signals SigS₁ to SigS′₄, which respectively control the on-off operations of the semiconductor switching units S₁ to S′₄, are calculated by comparing the calculated four carrier wave signals SW_{SigS1,S′1}, SW_{SigS2,S′2}, SW_{SigS3,S′3}, and SW_{SigS4,S′4} with the input voltage command V* respectively. The calculated rectangular wave type control signals SigS₁ to SigS′₄ are output to the semiconductor switching units S₁ to S′₄. The normal semiconductor switching units are turned on and off by the control signals SigS₁ to SigS′₄. Then a stepped AC voltage V_{ac} including four different voltage levels V₂, V₀, V₋₁, and V₋₂ can be output within the permissible voltage range for withstand voltages of the switching units S and the diode elements D. As a result, the five-level converter can be activated equivalently as a four-level converter, and even when any one of the semiconductor switching units S₁ to S′₄ fails, the power conversion operation can be continued. In addition, because the maximum and minimum values of the output voltage level are not changed in comparison with those in the normal state of the five-level converter, the output power is also unchanged.

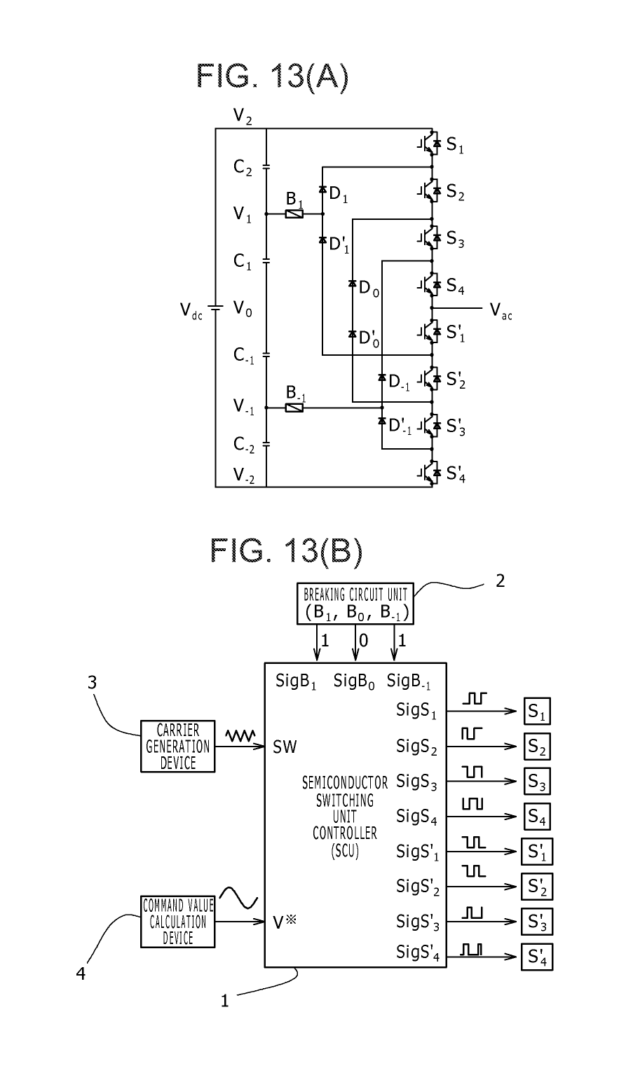

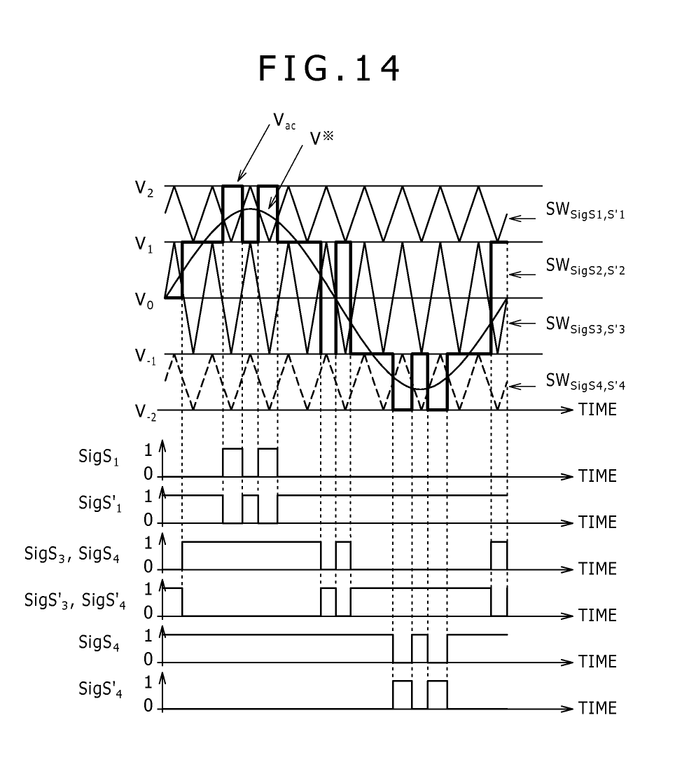

The semiconductor switching unit controller for the five-level converter in the case where the breaking circuit unit B₀ is activated as shown in FIG. 13(b) will be explained. As shown in FIG. 13(a), since the breaking circuit unit B₀is activated, the open/close state signals (SigB₁, Sigb₀, and SigB₋₁) output from the breaking circuit units, which are equal to (1, 0, 1), are input into the semiconductor switching unit controller. The semiconductor switching unit controller detects that the voltage level V₀ cannot be output judging from these signals, and expands, shrinks, and shifts the input carrier wave signal SW as shown in FIG. 14. In other words, the carrier wave signal SW_{SigS2,S′2},which has been expanded, shrunk, and shifted in the voltage level interval V₁-V₀ in the normal state, is expanded, shrunk, and shifted in the voltage level interval V₁-V₋₁, and in a similar way, the carrier wave signal SW_{SigS3,S′3}, which has been expanded, shrunk, and shifted in the voltage level interval V₀-V₋₁ in the normal state, is expanded, shrunk, and shifted in the voltage level interval V₁-V₋₁. This calculation makes the carrier wave signals SW_{SigS2,S′2} and SW_{SigS3,S′3} have the same values. Subsequently, in a similar way to the normal state, the rectangular wave type control signals SigS₁ to SigS′₄, which respectively control the on-off operations of the semiconductor switching units S₁ to S′₄, are calculated by comparing the calculated four carrier wave signals SW_{SigS1,S′1}, SW_{SigS2,S′2}, SW_{SigS3,S′3}, and SW_{SigS4,S′4} with the input voltage command V* respectively. The calculated rectangular wave type control signals SigS₁ to SigS′₄ are output to the semiconductor switching units S₁ to S′₄. The normal semiconductor switching units are turned on and off by the control signals SigS₁ to SigS′₄. Then a stepped AC voltage V_{ac} including four different voltage levels V₂, V₁, V₋₁, and V₋₂ can be output within the permissible voltage range for withstand voltages of the switching units S and the diode elements D. As a result, the five-level converter can be activated equivalently as a four-level converter, and even when any one of the semiconductor switching units S₁ to S′₄ fails, the power conversion operation can be continued. In addition, since the maximum and minimum values of the output voltage level are not changed in comparison with those in the normal state of the five-level converter, the output power is also unchanged.

Although not shown, in the case where the breaking circuit unit B₋₁ is activated, the carrier wave signal SW is expanded, shrunk, and shifted in the voltage level interval V₀-V₋₂ with the voltage level V₋₁, which cannot be output, and the carrier wave signals SW_{SigS3,S′3} and SW_{SigS4,S′4} are calculated in a similar way to the above-described cases. Subsequently, in a similar way to the normal state, the rectangular wave type control signals SigS₁ to SigS′₄, which respectively control the on-off operations of the semiconductor switching units S₁ to S′₄, are calculated by comparing the calculated four carrier wave signals SW_{SigS1,S′1}, SW_{SigS2,S′2}, SW_{SigS3,S′3}, and SW_{SigS4,S′4} with the input voltage command V* respectively. The calculated rectangular wave type control signals SigS₁ to SigS′₄ are output to the semiconductor switching units S₁ to S′₄. The normal semiconductor switching units are turned on and off by the control signals SigS₁ to SigS′₄. Then a stepped AC voltage V_{ac} including four different voltage levels V₂, V₁, V₀, and V₋₂ can be output within the permissible voltage range for withstand voltages of the switching units S and the diode elements D. As a result, the five-level converter can be activated equivalently as a four-level converter, and even when any one of the semiconductor switching units S₁ to S′₄ fails, the power conversion operation can be continued. In addition, since the maximum and minimum values of the output voltage level are not changed in comparison with those in the normal state of the five-level converter, the output power is also unchanged.

Even in the case where, after any one of the breaking circuit units B is activated, another operates, the behavior of the five-level converter is similar to the above-described cases, and the five-level converter can continue its power conversion operation as a three-level converter within the permissible voltage range for withstand voltages of the switching units S and the diode elements D. Detailed explanations about this case will be omitted.

The above-described behaviors of the five-level converter can be generalized. More specifically, an X-level converter, which outputs plural voltage levels, according to the present invention can continue its power conversion operation without reducing its output power by reducing the number of output levels into X-1 to 3, 2 sequentially in accordance with the operations of the breaking circuit units B within the permissible voltage range for withstand voltages of the switching units and the diode elements D included in the X-level converter even if some semiconductor switching elements fail.

### Second Embodiment

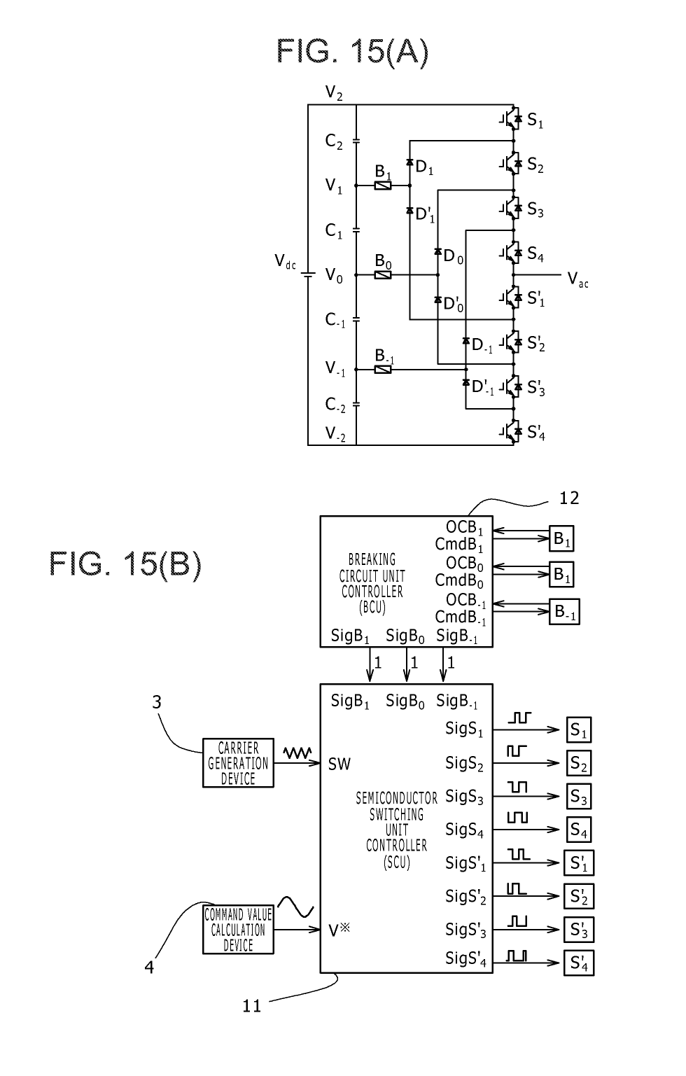

A second embodiment will be described with reference to FIG. 15(a) and FIG. 15(b). Here, explanations about matters, which are common to the first embodiment and this embodiment, will be omitted. This embodiment includes a breaking circuit unit controller 12 (BCU) that outputs binary signals SigB₁, SigB₀, SigB₋₁, which show the open/close states of breaking circuit units B, to a semiconductor switching unit controller 11 (SCU). The breaking circuit unit controller 12 (BCU) is a controller that outputs the open/close state signals SigB₁, SigB₀, and SigB₋₁ of the breaking circuit units B to semiconductor switching unit controller, and additionally outputs open/close command signals CmdB₁, CmdB₀, and CmdB₋₁ to the breaking circuit units B in accordance with excess current signals OCB₁, OCB₀, and OCB₋₁. The breaking circuit units B includes a mechanism that is capable of outputting the excess current signals OCB₁, OCB₀, and OCB₋₁ to the breaking circuit unit controller, and that is also capable of opening or closing their conductive routes respectively in accordance with the inputs of the breaking circuit open/close command signals CmdB₁, CmdB₀, and CmdB₋₁. Furthermore, the breaking circuit units B may answer back the binary signals SigB₁, SigB₀, and SigB₋₁, which show the open/close states, as operation results in response to the breaking circuit open/close command signals CmdB₁, CmdB₀, and CmdB₋₁.

The breaking circuit units B described in the first embodiment can be used as the breaking circuit units B for this embodiment. Furthermore, the breaking circuit units Bare not limited to the breaking circuit units B described in the first embodiment, and any other mechanisms can also be used as long as they have functions to open or close their conductive routes using command signals after detecting excess currents. However, if the breaking circuit units B comprise disconnecting devices, since the breaking circuit units B do not have a function of current breaking when they are in a current conducting state, when one of the breaking circuit units B detects an excess current, it outputs an excess current detection signal and the power conversion operation is stopped for a short time as needed. Subsequently, after the short-circuit current is attenuated, the corresponding disconnecting device is operated, and the power conversion operation is restarted in accordance with a behaviors similar to that performed in the first embodiment. In this case, it is necessary that this embodiment should include a mechanism for protecting capacitors C from the short-circuit current as needed.

Although short-circuit currents owing to the short-circuit failures of the respective semiconductor switching units S flow through the same routes as those described in the first embodiment, the open/close operations of the breaking circuit units B in this embodiment are performed in a similar way to the open/close operations performed in the first embodiment by controlling the open/close operations of the breaking circuit units B using the open/close command signals CmdB₁, CmdB₀, and CmdB₋₁ output from the breaking circuit unit controller 12 (BCU). It is also possible in the configuration of this embodiment that a five-level converter according to this embodiment can continue the power conversion operation as an equivalently lower-level converter within the permissible voltage range for withstand voltages of the switching units S and the diode elements D. Since the behavior of the power converter of this embodiment is the same as that of the first embodiment, a detailed explanation thereof will be omitted.

Because the breaking circuit units B according to this embodiment can be controlled using the open/close command signals CmdB₁, CmdB₀, and CmdB₋₁ output from the breaking circuit unit controller, the power converter of this embodiment can not only continue the operation of power conversion described in the first embodiment, but also can maintain the rectangular shape of an output voltage V_{ac} after the short-circuit failure of one of the semiconductor switching units S in an up-down symmetrical waveform regardless of which of the semiconductor switching units fails.

For example, in the case where the breaking circuit unit B₁ outputs the excess current signal OCB₁ owing to the short circuit failure of one of the semiconductor switching units S, the breaking circuit unit controller 12 (BCU) outputs a breaking operation command not only to the breaking circuit unit B₁, but also to the breaking circuit unit B₋₁, which connects a divided voltage level V₋₁ and another of the semiconductor switching units S in order to limit the output of the voltage level V₋₁ that is electrically symmetrical to a voltage level V₁ whose electric connection to the connection point of the one of the semiconductor switching units S is broken by the breaking circuit unit B₁. In other words, not only the open signal CmdB₁, but also the open signal CmdB₋₁ is output. In addition, the breaking circuit unit controller 12 (BCU) outputs the open/close state signals (SigB₁, SigB₀, SigB₋₁)=(0, 1, 0) to the semiconductor switching unit controller. Meanwhile, in the case where the breaking circuit unit B₋₁ outputs the excess current signal OCB₋₁, not only the open signal CmdB₋₁, but also the open signal CmdB is output. Furthermore, the breaking circuit unit controller 12 (BCU) outputs the open/close state signals (SigB₁, SigB₀, SigB₋₁)=(0, 1, 0) to the semiconductor switching unit controller.

The main circuit configuration of the five-level converter becomes equivalent to the main circuit configuration of a three-level converter shown in FIG. 2 by breaking a breaking circuit unit B symmetrical in terms of voltage level, and the five-level converter can output a stepped AC voltage _{Vac} including three different voltage levels V₂, V₀, and V₋₂ in an up-down symmetrical waveform within the permissible voltage range for withstand voltages of the switching units S and the diode elements D. As a result, the five-level converter can be activated equivalently as a three-level converter, and even when any one of the semiconductor switching units S₁ to S′₄ fails, the power conversion operation can be continued. In addition, since the maximum and minimum values of the output voltage level are not changed in comparison with those in the normal state of the five-level converter, the output power is also unchanged.

Furthermore, for example, in the case where the breaking circuit unit B₀ outputs the excess current signal OCB₀ owing to one of the short circuit failure of semiconductor switching units S, the breaking circuit unit controller 12 (BCU) outputs only a release signal CmdB0 if there is no voltage level electrically symmetrical to the voltage level V0 whose electric connection to the connection point of the one of the semiconductor switching units S is broken by the breaking operation of the breaking circuit unit B0, and further the breaking circuit controller outputs the open/close state signals (SigB₁, SigB₀, SigB₋₁)=(1, 0, 1) to the semiconductor switching unit controller. In a power converter is an odd number-level converter, it does not have a voltage level that is electrically symmetrical to the central voltage level. The main circuit configuration of the five-level converter is activated as a four-level converter shown in FIG. 3 by maintaining the connection state of the breaking circuit unit B that is asymmetrical in terms of voltage level, and the power conversion operation can be continued within the permissible voltage range for withstand voltages of the switching units S and the diode elements D when any one of the semiconductor switching units S₁ to S′₄ fails. Since the maximum and minimum values of the output voltage level are not changed in comparison with those in the normal state of the five-level converter, the output power is also unchanged.

As described above, the breaking circuit unit controller selectively outputs an open signal to one of the breaking circuit units B in accordance with a voltage level where an excess current is detected, which enables the output voltage V_{ac} to remain in a symmetrically rectangular waveform even at the time of failure. Therefore, the middle voltage level variation of average output per unit time of the output voltage V_{ac} generated by the continuous running of the power converter can be minimized.

In addition, in a power converter that converts multiphase AC power using plural phase units for a three-phase AC or the like, by issuing an open command signal CmdB for a voltage level, which is equal to the voltage level of a failed phase unit, to normal phase units other than the failed phase unit via breaking circuit unit controllers of the respective normal phases, an advantageous effect of minimizing a negative-phase-sequence component and a zero-phase-sequence component of a multiphase AC voltage generated by the continuous running of the power converter can be obtained, and the amount of unnecessary power , which is supplied to a load connected to the power converter, can be reduced, wherein, for example, in the case where the normal phase sequence of a three-phase AC is a sequence of U, V, and W phases, and a normal output is an output with this phase sequence, while the negative phase sequence means that it is a phase sequence in which any two of the U, V, and W phases are not in the right order, and a zero phase component is, for example, an average output voltage of instantaneous output voltages of a three-phase AC, and a zero phase means a state in which a DC component is added to a three-phase AC component.

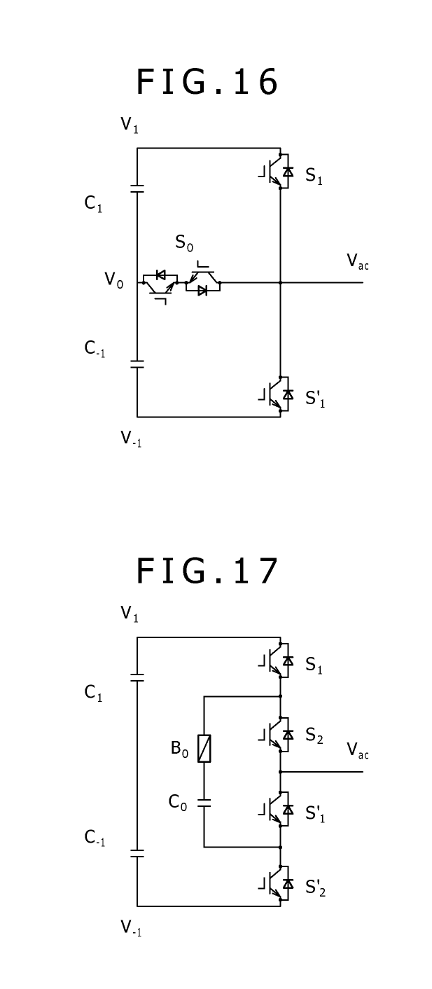

Although diode clamp type X-level converters have been described in the above embodiments, it goes without saying that the present invention can be applied to other types of converters. For example, in an active clamp type X-level converter shown in FIG. 16 (actually, a three-level converter is shown as an example), a bidirectional semiconductor switching unit S₀, which controls the output of a voltage level V₀, includes two semiconductor switching units connected in antiseries, wherein each of the two semiconductor switching units includes an IGBT element and a diode connected to the IGBT element in antiparallel, and the bidirectional semiconductor switching unit S₀ goes into an open failure state when an excess current flows therethrough, which enables a combination of the bidirectional semiconductor switching unit S₀ and the semiconductor switching unit controller according to the present invention to function as the breaking circuit unit B₀. As a result, the active clamp type three-level converter can continue its power conversion operation as a two-level converter in the case where a semiconductor switching unit S₀ goes into an open failure state.

Alternatively, as shown in FIG. 17, in a flying capacitor type X-level converter that outputs plural different voltage levels (actually, a three-level converter is shown as an example), pairs of connection portions of the semiconductor switching units S are electrically connected with no overlaps via capacitors to which different voltage levels are applied, the on-off operations of the semiconductor switching units are switched, and a flying capacitor C₀ and a breaking circuit unit B₀ are connected in series, thereby this flying capacitor type X-level converter can continue its power conversion operation as a two-level converter by electrically disconnecting the flying capacitor C₀ from the circuit of its own using the breaking circuit unit B₀ when a semiconductor switching unit S₁ or S′₁ goes into a short failure state. Although descriptions have been made about single-phase power converters and three-phase power converters in the above embodiments, the present invention can be applied to a four- or more-phase power converter or an arbitrary number-level power converter.

### LIST OF REFERENCE SIGNS

SCU: Semiconductor Switching Unit Controller

BCU: Breaking Circuit Unit Controller

S: Semiconductor Switching Unit

D: Diode, Free Wheeling Rectifying Element

C: Capacitor

B: Breaking Circuit Unit

V: Voltage

SW: Carrier Wave Signal

SigS: Semiconductor Switching Unit Control Signal

SigB: Breaking Circuit Unit State Signal

OCB: Breaking Circuit Unit Excess Current Signal

CmdB: Breaking Circuit Unit Control Signal

1. A power converter in which:
a plurality of semiconductor switching units, each including an on-off switchable semiconductor switching element and a rectifying element connected to the semiconductor switching element in antiparallel, are connected,
when a DC voltage is applied to the power converter, the DC voltage is divided into a plurality of different voltage levels,
parts having the plurality of different voltage levels and connection portions where the semiconductor switching units are connected to each other are electrically connected to each other, and the plurality of different voltage levels are output using the DC voltage by switching the semiconductor switching elements on and off,
wherein any one of the semiconductor switching elements becomes conductive when it fails,
the power converter includes open/close units being disposed between the parts having the plurality of different voltage levels and the connection portions where the semiconductor switching units, which are to be connected to the parts having the different voltage levels, are connected to each other,
when an excess current flows through any one of open/close units, the open/close unit opens a current path between the part having the corresponding voltage level and the connection portion where the corresponding semiconductor switching units are connected to each other, and
the open/close states of the open/close units are detected, and when any one of the open/close units is in an open state, the voltage to which the open/close unit is connected is not output, thereby the number of output voltage levels is reduced.

2. The power converter according to claim 1, wherein the open/close units are breaking circuit units capable of conducting or breaking currents.

3. The power converter according to claim 2, wherein the breaking circuit units include a plurality of switching elements in which rectifying elements are connected in antiserial.

4. The power converter according to claim 1,
wherein the open/close units are disconnecting units each of which is capable of switching to its current conducting position or its disconnecting position, and
when any one of the disconnecting units is switched to its disconnecting position, the operation of the power converter is stopped, and the disconnecting unit is switched to its disconnecting position through the disconnecting unit being operated after the excess current is attenuated.

5. The power converter according to claim 1, wherein any two open/close units are not switched to an open state simultaneously if, among the plurality of different voltage levels, two voltage levels respectively applied to the two open/close units are asymmetrical to each other with respect to the central voltage level.

6. The power converter according to claim 2, wherein the breaking circuit units are fuses, and any two fuses have current square time products different from each other if, among the plurality of different voltage levels, two voltage levels respectively applied to the two fuses are asymmetrical to each other with respect to the central voltage level.

7. The power converter according to claim 1, further comprising a control unit that issues an open command or a close command to the open/close units,
wherein, when an excess current is detected, the control unit issues the open command to the corresponding open/close unit.

8. The power converter according to claim 7, wherein, when the open command is issued to one of the open/close units, the open command is also issued to another open/close unit to which, among the plurality of different voltage levels, a voltage level, which is approximately symmetrical to the voltage level applied to the one of the open/close units with respect to the central voltage level, is applied.

9. The power converter according to claim 7, wherein, when the open command is issued to the one of the open/close units and the central voltage level among the plurality of different voltage levels is applied to the one of the open/close units, the open command is issued to only the one of the open/close units.

10. The power converter according to claim 2, further comprising:
a command value calculation device issuing a voltage;
a carrier generation device outputting a carrier wave signal; and
a semiconductor switching unit controller that receives open/close state signals showing the open/close states of the breaking circuit units, the output voltage command output from the command value calculation device, and the carrier wave signal output from the carrier generation device while issuing on-off commands to the respective semiconductor switching elements,
wherein, if the open/close state signals include a signal showing an open state, a carrier wave signal that varies between a voltage level to which a breaking circuit unit in an open state is connected and another voltage level is expanded by omitting the voltage level to which the breaking circuit unit in an open state is connected, thereby the number of output voltage levels is reduced.

11. The power converter according to claim 10, further comprising a breaking circuit unit controller that outputs open/close state signals for the breaking circuit units,
wherein the breaking circuit units output excess current signals to the breaking circuit unit controller,
the breaking circuit unit controller outputs open/close command signals to the breaking circuit units in accordance with the excess current signals, and
the breaking circuit units switch their own open/close states in accordance with the open/close command signals.

12. The power converter according to claim 11, wherein, when the open command is issued to one of the breaking circuit units, the open command is also issued from the breaking circuit unit controller to another breaking circuit unit to which, among the plurality of different voltage levels, a voltage level, which is approximately symmetrical to the voltage level applied to the one of the breaking circuit units with respect to the central voltage level, is applied.

13. The power converter according to claim 11, wherein, when the open command is issued to one of the breaking circuit units and the central voltage level among the plurality of different voltage levels is applied to the one of the breaking circuit units, the open command is issued from the breaking circuit unit controller to only the one of the breaking circuit units.

14. A flying capacitor type power converter in which:
a plurality of semiconductor switching units, each including an on-off switchable semiconductor switching element and a rectifying element connected to the semiconductor switching element in antiparallel, are connected,
pairs of connection portions of the semiconductor switching units have capacitors, each of which electrically connects a pair of the connection portions with no overlaps, different voltage levels are applied to the respective capacitors, and a plurality of different voltage levels are output by switching the semiconductor switching elements on and off,
wherein any one of the semiconductor switching elements becomes conductive when it fails,
a breaking circuit unit is connected to each of the capacitors in series, while the breaking circuit unit breaks an excess current if the excess current flows through the breaking circuit unit,
the current conducting or current breaking states of the breaking circuit units are detected, and when any one of the breaking circuit units is in a current breaking state, the voltage to which the breaking circuit unit is connected is not output, thereby the number of output voltage levels is reduced.

15. A multiple-phase power converter including a plurality of the power converters according to claim 1 for a plurality of phases, wherein, when one of the open/close units of a power converter for one phase goes into an open state, the open command is also issued to one of the open/close units of each of power converters for the remaining phases, to which a voltage level, which is approximately the same as the voltage level applied to the one of the open/close units of the power converter for the one phase that goes into an open state, is applied.

16. A multiple-phase power converter including a plurality of the power converters according to claim 14 for a plurality of phases, wherein,
when one of the open/close units of a power converter for one phase goes into an open state, the open command is also issued to one of the open/close units of each of power converters for the remaining phases, to which a voltage level, which is approximately the same as the voltage level applied to the one of the open/close units of the power converter for the one phase that goes into an open state, is applied.
